(19) United States
(12) Patent Application Publication
(10) Pub. No.: US 2022/0062671 A1
(43) Pub. Date: Mar. 3, 2022

(54) Face Mask

(71) Applicant: Courtenay Kanyikirize, (US)

(72) Inventors: Courtenay Kanyikirize, Los Angeles, CA (US); Paul Alan Berman, Santa Monica, CA (US); Linda Shayne, Santa Monica, CA (US)

(73) Assignee: Courtenay Kanyikirize, Los Angeles, CA (US)

(21) Appl. No.: 17/411,184

(22) Filed: Aug. 25, 2021

Related U.S. Application Data
(60) Provisional application No. 63/072,558, filed on Aug. 31, 2020.

(51) Int. Cl. A62B 18/08; A41D 13/11

(52) U.S. Cl. CPC A62B 18/086; A41D 13/1161

(57) ABSTRACT

A face mask that allows a wearer to consume a beverage through the mask when worn. The face mask includes a facepiece capable of covering a nose and mouth of a wearer. A pair of straps extend from opposing sides of the facepiece to secure the face mask around the ears or head of the wearer. An aperture sized to receive a straw is disposed through the facepiece and positioned proximate to the mouth of the wearer when worn. A moveable panel extends from a front side of the facepiece and can transition between a covered and an in-use configuration. In the covered configuration, a free end of the movable panel is secured to the facepiece in a first position such that the aperture is concealed by the moveable panel. In the in-use configuration, the moveable panel is secured to a second position on the facepiece to reveal the aperture.

### CROSS REFERENCE TO RELATED APPLICATION

This application claims the benefit of U.S. Provisional Application No. 63/072,558 filed on Aug. 31, 2020. The above identified patent application is herein incorporated by reference in its entirety.

### BACKGROUND OF THE INVENTION

The present invention relates to a face mask device. The present invention further provides a face mask with a moveable panel adapted to selectively reveal and conceal an aperture in the mask, wherein the aperture is sized to receive a straw.

Face masks are commonly used in preventing the spread of bacteria and viruses. Experts report that simple coverings for the nose and mouth can help in combatting the spread of harmful illnesses. Typical face masks are composed of a cloth fitted over the nose and mouth with straps fitted around the ears. Such masks are greatly restrictive in the capabilities of the wearer, with the mask covering the mouth and preventing eating and drinking. Due to these restrictions, mask users must lift or remove their mask in order to partake in eating or drinking. This puts the user and those around them at risk for possible illness transmission. Therefore, there is a need in the prior art for a face mask that allows a user to consume food or beverages without having to remove a protective face mask covering.

The present invention provides a face mask device for restricting illness transmission with a moveable panel to selectively reveal an aperture in the mask. The moveable panel is positioned proximate to a wearer's mouth. The moveable panel is secured to the facepiece in the covered and in-use position via magnetic fasteners. In the in-use position, the moveable panel is secured to a separate location on the face mask to reveal the aperture. This mask is beneficial as it protects the wearer and those around them by providing a secure mask while allowing for selective access to the oral region.

In light of the devices disclosed in the known art, it is submitted that the present invention substantially diverges in design elements and methods from the known art and consequently it is clear that there is a need in the art for an improvement for face mask devices. In this regard the instant invention substantially fulfills these needs.

### SUMMARY OF THE INVENTION

In view of the foregoing disadvantages inherent in the known types of face mask devices now present in the known art, the present invention provides a new face mask device with a moveable panel to selectively reveal an aperture panel in the mask for drinking out of a straw.

It is an objective of the present invention to provide a face mask configured to cover the mouth and nose with a facepiece, wherein the facepiece includes a moveable panel extending from a front side thereof.

It is another objective of the present invention to provide a face mask having an aperture disposed through the facepiece, wherein the opening is proximate to the user's mouth.

It is another objective of the present invention to provide a face mask wherein the moveable panel selectively covers and conceals the aperture in a first position and second position, selectively.

It is another objective of the present invention to provide a face mask wherein the moveable panel is attached to the facepiece by a magnet as to reveal the aperture over the mouth.

It is another objective of the present invention to provide in some embodiments, the face mask wherein the aperture is sized to receive a straw for the user to consume a beverage therethrough.

It is yet another objective of the present invention to provide a face mask for reducing the spread of illnesses. This mask prevents the spread of illnesses such as viruses and bacteria by covering the mouth and concealing coughs, sneezes, and breaths.

It is therefore an object of the present invention to provide a new and improved face mask device that has all of the advantages of the known art and none of the disadvantages.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of a first embodiment of the face mask.

FIG. 2 shows a perspective view of a second embodiment of the face mask, wherein the moveable panel is in a covered configuration.

FIG. 3 shows a perspective view of a second embodiment of the face mask, wherein the moveable panel is transitioning between a covered configuration and an in-use configuration.

FIG. 4 shows a perspective view of a second embodiment of the face mask, wherein the moveable panel is in an in-use configuration.

FIG. 5 shows a perspective view of a third embodiment of the face mask, wherein the moveable panel is in a covered configuration.

FIG. 6 shows a perspective view of a third embodiment of the face mask, wherein the moveable panel is in an in-use configuration.

### DETAILED DESCRIPTION OF THE INVENTION

Reference is made herein to the attached drawings. Like reference numerals are used throughout the drawings to depict like or similar elements of the face mask. For the purposes of presenting a brief and clear description of the present invention, the preferred embodiment will be discussed as used for covering the nose and mouth of a user while allowing a user to consume food or beverage while wearing the face mask. The figures are intended for representative purposes only and should not be considered to be limiting in any respect.

Reference will now be made in detail to the exemplary embodiment (s) of the invention. References to “one embodiment,” “at least one embodiment,” “an embodiment,” “one example,” “an example,” “for example,” and so on indicate that the embodiment(s) or example(s) may include a feature, structure, characteristic, property, element, or limitation but that not every embodiment or example necessarily includes that feature, structure, characteristic, property, element, or limitation.

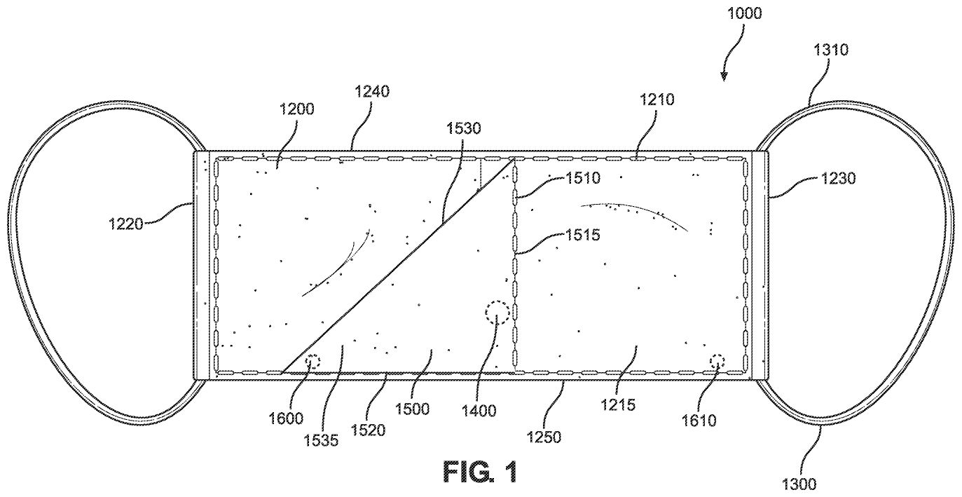

Referring now to FIG. 1, there is shown a perspective view of a first embodiment of the face mask. The face mask 1000 comprises a facepiece 1200 adapted to cover a nose and a mouth of a wearer. The facepiece 1200 is composed of any suitable material configured to allow the wearer to breath therethrough, such as cloth. In the illustrated embodiment, the facepiece 1200 comprises a single layer of material. However, in alternate embodiments, the facepiece 1200 comprises additional layers for comfort and additional filtration, among other functions. In some embodiments, the facepiece comprises an interior pocket for receiving additional filtration layers.

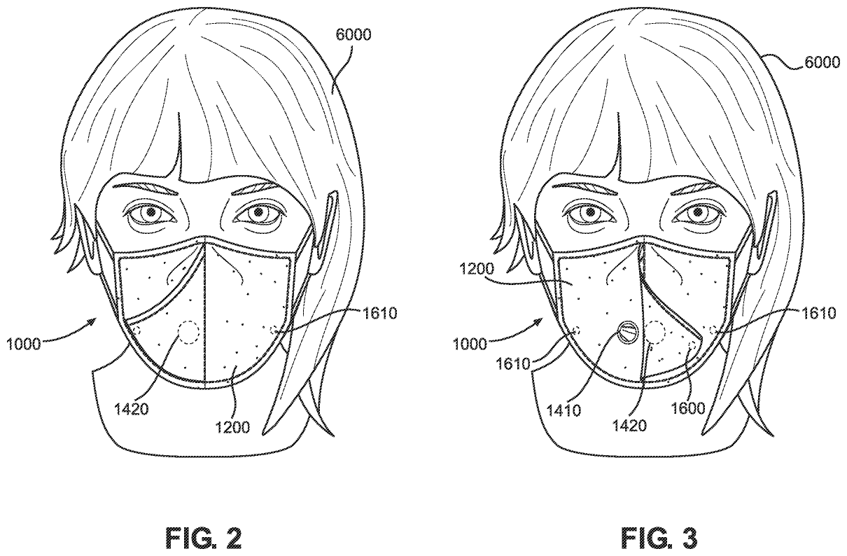

The shape of the facepiece 1200 comprises a substantially symmetrical shape to conform to a shape of the wearer's face. However, in alternate embodiments, the facepiece 1200 comprises any suitable shape. In the illustrated embodiment, the facepiece 1200 comprises a substantially rectangular shape. However, in alternate embodiments, such as shown in FIGS. 2-6, the facepiece 1200 comprises any suitable shape. In the illustrated embodiment, piping 1210 is positioned along a periphery of the facepiece to provide additional comfort and securement against the wearer's skin.

The face mask 1000 comprises a facepiece fastener configured to secure the facepiece to the wearer. In the illustrated embodiment, the facepiece fastener 1300 comprises a pair of straps 1310 extending from opposing first and second lateral sides 1220, 1230 of the facepiece 1200. The pair of straps 1310 are adapted to secure around the ears of the wearer, wherein each strap forms a loop. In this way, the facepiece 1200 is secured to the wearer. In some embodiments the straps are adjustable such that the size of the loop is adjustable to fit wearers having different head shapes and sizes. In some embodiments, the straps are elastic. In alternate embodiments, an adjustment mechanism, such as a buckle or clasp, is disposed along the strap.

An aperture 1400 is disposed through the facepiece 1200 and positioned proximate to the mouth of the wearer when the face mask 1000 is donned. In the illustrated embodiment, the aperture is sized to receive a straw therethrough. The aperture 1400 is surrounded by a waterproof structure, such as a grommet or ring (as seen in FIG. 3, 1410), to prevent liquid on the straw from contacting or wetting the material of the facepiece 1200. In alternate embodiments, the aperture is larger to allow a user to take a bite of food or drink a beverage directly from a bottle. However, in the illustrated embodiment, the aperture 1400 is not configured to extend over the nose of the wearer. In the illustrated embodiment, the aperture 1400 is positioned centrally between the opposing sides 1220, 1230 of the facepiece 1200.

The face mask 1000 further comprises a moveable panel 1500 extending from a front side 1215 of the facepiece 1200 and configured to selectively and removably cover the aperture 1400. The moveable panel 1500 is adapted to transition between a covered configuration and an in-use configuration. In the shown embodiment, the moveable panel 1500 is secured to the facepiece 1200 via a vertical seam 1510 on the front side 1215 of the facepiece 1200. In alternative embodiments, the moveable panel is secured via seam or other fastener in another orientation or position along the facepiece. In the illustrated embodiment, the vertical seam 1510 is offset from the center of the facepiece 1200 to cover the aperture 1400 positioned centrally on the facepiece 1200.

In the illustrated embodiment, the moveable panel 1500 comprises a substantially triangular shape having a first side 1515 secured to the facepiece 1200 and a second and third side 1520, 1530 forming a free end 1535. The first side 1515 comprises the vertical seam 1510 and extends an entire vertical length of the facepiece, wherein the vertical length is measured between the upper and lower ends 1240, 1250 of the facepiece 1200. In the illustrated embodiment, the moveable panel 1500 can transition between the covered configuration and the in-use configuration by moving the free end 1535 of the panel from left to right. In the covered configuration, the free end 1535 of the movable panel 1500 is secured to the facepiece 1200 in a first position such that the aperture 1400 is concealed by the moveable panel 1500. The free end 1535 covers or conceals the aperture 1400 and secures to a lower corner of the first side 1220 of the facepiece 1200.

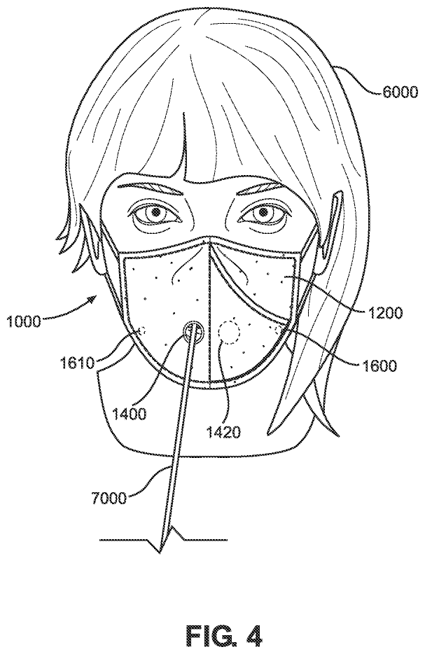

In the in-use configuration, the moveable panel 1500 is secured to a second position on the facepiece 1500 so as to reveal the aperture 1400 (as seen in FIGS. 3 and 4). The free end 1535 is folded over the vertical seam and secured to the second side 1230 of the facepiece 1200. In the illustrated embodiment, the free end 1535 is secured to the first and second positions via magnetic fasteners such as a magnet 1600 and a steel disc 1610. In the illustrated embodiment, each side of the magnetic fastener 1600, 1610 is sandwiched between an inner layer and an outer layer of fabric. The fastener 1600, 1610 is held in place with stitching that surrounds and attaches the inner layer to the outer layer of the fabric so that the magnet 1600 and steel discs 1610 do not slide around between the two layers of fabric. In some embodiments, the magnet 1600 is located near the free end 1535 or vertex of the moveable panel 1500 and attaches to steel discs 16100 that are located along the perimeter of the first and second sides 1220, 1230 of the facepiece 1200. In an alternate embodiment, the steel discs are replaced with disc shaped magnets. In other embodiments, any suitable mating fasteners are used to removably secure the moveable panel 1500 between the first and second positions, such as hook and look fasteners, snaps, clips, adhesive, and the like.

In some embodiments, both the covered and in-use configurations, the second side 1520 of the free end 1535 is adapted to align with the periphery of the facepiece 1200 to form a continuous perimeter. In alternate embodiments, the moveable panel can be any shape or secured between the first and second positions in any number of ways as long as in the covered configuration the aperture is concealed and in the in-use configuration the aperture is uncovered to allow a user to access a straw while simultaneously wearing the face mask.

Referring now to FIGS. 2-4, there is shown a perspective view of a second embodiment of the face mask wherein the moveable panel is in a covered configuration, a perspective view wherein the moveable panel is transitioning between a covered configuration and an in-use configuration, and a perspective view wherein the moveable panel is in an in-use configuration, respectively. In the illustrated embodiment, the aperture 1400 is offset from the center of the facepiece 1200 and the moveable panel 1500 is secured to a center of the facepiece 1200. The aperture 1400 is still positioned proximate to the mouth of the wearer 6000 when the face mask 1000 is worn.

In some embodiments, a ferrous ring or grommet 1410 surrounds the aperture 1400 of the face mask 100, wherein a disc shaped magnet or other fastener 1420 is sewn or attached to the moveable panel 1500 so that when the moveable panel 1500 covers the aperture 1400, the ferrous ring 1410 is covered by and attracted to the disc shaped magnet 1420. In this way, the ferrous ring and magnet form a nearly airtight seal between the moveable panel 1500 and the facepiece 1200 in the covered configuration.

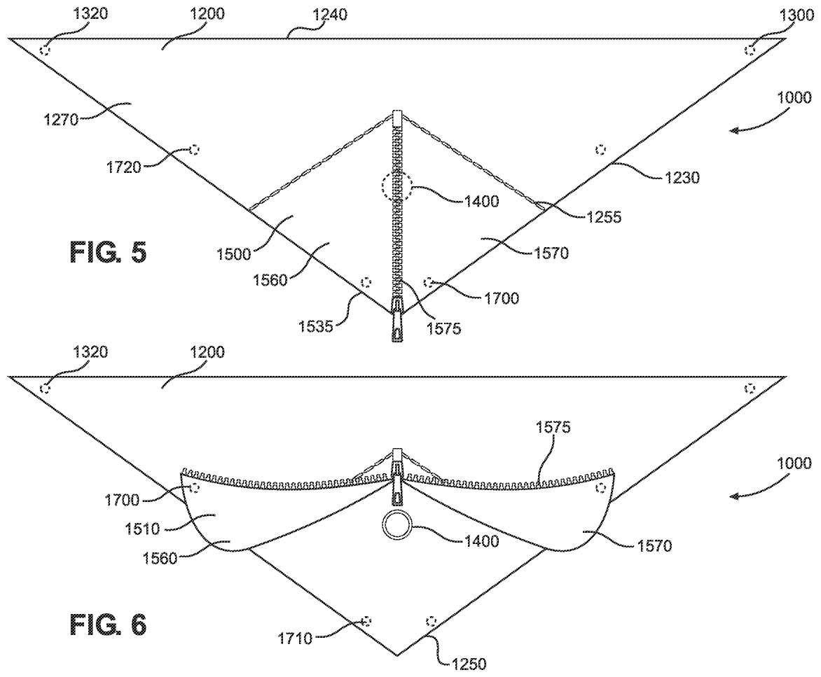

Referring now to FIGS. 5 and 6, there is shown a perspective view of a third embodiment of the face mask, wherein the moveable panel is in a covered configuration and a perspective view wherein the moveable panel is in an in-use configuration. In an alternative embodiment, the face mask 1000 comprises a scarf configuration as opposed to having a pair of straps securing the facepiece 1200 to the wearer's ears. In the illustrated embodiment, the face mask 1200 comprises a substantially triangular shape, wherein the upper end 1240 of the face mask 1200 forms a loop around the head of the wearer and is attached behind the neck via facepiece fastener 1300. In the illustrated embodiment, the facepiece fastener 1300 is a pair of ends or adjacent corners of the facepiece 1200 each having a mating fastener 1320, such as a magnet, thereon. The first and second sides 1220, 1230 of the facepiece 1200 are adapted to be positioned on opposing sides of the wearer's face when donned.

The aperture 1400 is positioned centrally between the first and second sides 1220, 1230 of the face mask 1000, along a lower end 1250 thereof. The face mask 1000 comprises a movable panel 1500 formed by a first and second section 1560, 1570 that are connectable to one another along an inner edge 1575 therebetween. The moveable panel 1500 is connected to the facepiece 1200 via a substantially horizontal seam 1255 disposed above the aperture 1400. In the illustrated embodiments, the first and second sections 1560, 1570 are connectable via a zipper fastener along the inner edge, wherein the free end 1535 of the moveable panel 1500 is positioned at the lower end 1250 of the facepiece 1200 when in the covered configuration.

In the covered configuration, the first and second sections 1560, 1570 of the moveable panel 1500 are attached to the lower end 1250 of the facepiece 1200 in the first position via a mating fastener 1700, 1710 disposed on both the moveable panel 1500 and the facepiece 1200, such as a magnet. In the illustrated embodiment, the mating fasteners 1700, 1710 are disposed on both the first side and the second side of the facepiece 1200. In some embodiments, the moveable panel 1500 remains suspended in the covered configuration but is not attachable to the lower end 1250 of the facepiece.

In the in-use configuration, the first and second sections 1560, 1570 are individually secured to the second position on the facepiece via another mating fastener positioned along each of the sides of the facepiece so as to reveal the aperture 1400 and maintain the moveable panel 1500 in a lifted and separated position. In this way, the zipper fastener is opened, and the sections are fixed to the second position fasteners 1720 to reveal the aperture 1400 until repositioned to the covered configuration.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A face mask, comprising:
a facepiece adapted to cover a nose and a mouth of a wearer;
a facepiece fastener configured to secure the facepiece to the wearer;
wherein the facepiece comprises an aperture disposed, wherein the aperture is sized to receive a straw therethrough and adapted to align over the mouth of the wearer when in use;
a moveable panel extending from a front side of the facepiece;
wherein the moveable panel is adapted to transition between a covered configuration and an in-use configuration;
wherein the covered configuration, a free end of the movable panel is secured to the facepiece in a first position such that the aperture is concealed by the moveable panel;
wherein the in-use configuration, the moveable panel is secured to a second position on the facepiece so as to reveal the aperture.

2. The face mask of claim 1, wherein the facepiece fastener comprises a pair of straps extending from opposing sides of the facepiece adapted to secure around ears of the wearer and secure the face mask thereto.

3. The face mask of claim 1, wherein the moveable panel comprises a first fastener disposed on the free end thereof and the facepiece comprises a second fastener disposed on a lower end of a first side and a third fastener disposed on the lower end of an opposing second side.

4. The face mask of claim 3, wherein the second and third fasteners comprise steel discs and the first fastener is a magnet.

5. The face mask of claim 3, wherein the free end of the movable panel is secured to in the first and second positions via magnets.

6. The face mask of claim 1, wherein the moveable panel comprises a triangular shape having a first side secured to the facepiece, wherein a second side and a third side form the free end.

7. The face mask of claim 6, wherein the first side of the moveable panel extends linearly from an upper end of the facepiece to a lower end of the facepiece.

8. The face mask of claim 7, wherein the first side of the moveable panel is offset from a center of the facepiece, wherein the center is defined between a pair of opposing lateral sides of the facepiece.

9. The face mask of claim 1, wherein the moveable panel is sewn directly onto the facepiece.

10. The face mask of claim 1, wherein the moveable panel is adapted to transition side to side between the covered configuration and the in-use configuration.

11. The face mask of claim 1, wherein the moveable panel comprises a pair of adjoining sections disposed on opposing sides of the facepiece, and each adapted to be lifted upwards from the covered configuration to the in-use configuration.

12. The face mask of claim 11, wherein each adjoining section comprises a free end having a fastener thereon such that when independently lifted, a first adjoining section is securable to a first corresponding fastener disposed on a first side of the facepiece and a second adjoining section is securable to a second corresponding fastener disposed on an opposing second side of the facepiece.

13. The face mask of claim 11, wherein the adjoining sections are removably secured to one another along an interior side thereof.

14. The face mask of claim 11, wherein each of the adjoining sections comprise a triangular shape.

15. The face mask of claim 11, wherein the moveable panel is only permanently secured to the facepiece along one side of the moveable panel.

16. The face mask of claim 11, wherein the moveable panel is disposed along a lower side of the facepiece.

17. The face mask of claim 1, wherein the aperture is offset from a center of the facepiece and the moveable panel is secured to the center of the facepiece, wherein the center is measured between a pair of opposing lateral sides of the facepiece.

18. The face mask of claim 1, wherein the aperture is surrounded by a waterproof structure to prevent liquid from contacting the facepiece.
